(19) United States
(12) Patent Application Publication
(10) Pub. No.: US 2025/0153803 A1
(43) Pub. Date: May 15, 2025

(54) SENSOR SYSTEM FOR DETERMINING AN EXERTION OF FORCE ON A PEDAL, DRIVE UNIT, SENSOR UNIT, AND METHOD FOR ADJUSTING AN ASSISTANCE POWER OF A DRIVE UNIT

(71) Applicant: PORSCHE EBIKE PERFORMANCE GMBH, Ottobrunn (DE)

(72) Inventors: Johannes BIECHELE, Riedering (DE); Linda REUTER, München (DE)

(21) Appl. No.: 18/838,510

(22) PCT Filed: Feb. 14, 2023
(86) PCT No.: PCT/EP2023/053655

§ 371 Date: Aug. 14, 2024

(30) Foreign Application Priority Data
Feb. 16, 2022 (DE) 10 2022 103 666.9

(51) Int. Cl. B62M 6/50; B62J 45/411; B62J 45/413; B62J 45/414; B62J 45/421

(52) U.S. Cl. CPC B62M 6/50; B62J 45/411; B62J 45/413; B62J 45/414; B62J 45/421

(57) ABSTRACT

A sensor system having a sensor unit for determining the exertion of a force on a pedal of a bicycle, wherein the sensor unit is connected in a rotationally fixed manner to a crankshaft of the bicycle, which is connected to the pedal, wherein the sensor unit includes at least one sensor, which detects a value at the crankshaft representing the exertion of force. A drive unit for providing a support power for a bicycle is also related, the drive unit having a sensor system, a sensor unit with a ring for rotationally fixed connection to a crankshaft of a bicycle, and a method for setting support power of a drive unit of a bicycle.

### CROSS-REFERENCE TO RELATED APPLICATIONS

This application is a 35 U.S.C. § 371 National Stage patent application of PCT/EP2023/053655 filed 14 Feb. 2023, which claims the benefit of German patent application 10 2022 103 666.9 filed 16 Feb. 2022, the disclosures of which are incorporated herein by reference in their entirety.

### TECHNICAL FIELD

The disclosure relates to a sensor system for determining the exertion of a force on a pedal according to the disclosure. The disclosure further relates to a drive unit having such a sensor system according to the disclosure and a sensor unit according to the disclosure. The disclosure also relates to a method for setting support power of a drive unit according to the disclosure.

### BACKGROUND

In current bicycles having a drive unit—also termed an e-bike, electric bicycle or pedelec—it is known to adjust the support power from the drive unit to the cadence with which a person pedals and especially to the force exerted by the person on a pedal. This adjusted support power from the drive unit should lead to a pleasant and natural riding experience.

It is known from the prior art to determine the application of force on the pedal either by means of strain gauges by means of torque sensors. For determining the torque by means of torque sensors, conventionally part of the crankshaft is magnetized or provided with magnetic material (passive torque sensor) or a demagnetized material is used (active torque sensor) and the torque acting on the crank is then determined by means of a non-co-rotating torque sensor which is arranged stationary on the frame.

The cadence is generally determined by means of Hall effect sensors. The power instantaneously produced by the user of the bicycle is determined from that together with the rotational speed of the crankshaft, which may be measured by further sensors or else determined computationally.

Magnet-based sensors in particular have the disadvantage, inter alia, that they take up a comparatively large amount of installation space. In addition, other magnetized components in the region of the torque sensor may distort the measured values. This means that, for the assembly of a bicycle or a drive unit, the individual components must be subjected to complex demagnetization processes.

### SUMMARY

The present disclosure provides an alternative sensor system and an alternative method for setting a support power, wherein only little installation space is taken up and additionally the assembly can take place in a particularly simple manner.

This is achieved by providing the features of the independent claims. Further embodiments and advantages are described in connection with the dependent claims.

A sensor system according to the disclosure comprises a sensor unit for determining the exertion of a force on a pedal of a bicycle. The sensor unit is connected in a rotationally fixed manner to a crankshaft of the bicycle, which is connected to the pedal. The crankshaft is in particular connected to a first pedal and a second pedal by means of a crank in each case. Due to the actuation of the pedal, a torque is transmitted to the crankshaft via the cranks. The crankshaft is particularly rotatably mounted in a frame of a bicycle. The sensor unit can be arranged directly on the crankshaft or indirectly connected to the crankshaft.

The sensor unit further comprises at least one sensor, which detects a value at the crankshaft representing the exertion of force. Here, a value representing the exertion of force is understood to mean a value which changes directly at the crankshaft due to changed exertion of force on the pedal. If a person pedals harder on the pedal, then this for example leads to a change of the acceleration of the crankshaft, to a change of the rotational speed, a change of the angular velocity and also to a change of the circumferential speed of the crankshaft (angular acceleration or circumferential acceleration). Therefore, in the present case, the exertion of force on the pedal is not detected directly, but rather at least one change of a measured value at the crankshaft, triggered by the exertion of a force, is detected. The measurement of the exertion of force consequently takes place indirectly here, e.g. by means of the change of the rotational speed of the crankshaft or the change of the circumferential speed (acceleration). Also, no absolute exertion of force on the crankshaft is detected by the present sensor unit, but rather in particular only relative values or a change in the exertion of force is detected at the crankshaft.

Usually, a bicycle comprises two pedals, and in particular the exertion of force, which is transmitted by both pedals to the crankshaft, is detected by the sensor. It may additionally be the case that the pedals are constructed as clipless pedals and force is exerted on the pedals during an entire revolution of the pedals.

Overall, the detected measured value representing the exertion of force should be used in order to adjust the drive power of a drive unit. An adjusted drive power means in particular that the drive power is adjusted to the cyclical pedalling movement of the person. Correspondingly more support is provided by the drive unit in the phases of a pedalling cycle in which the most force is exerted on a pedal. The exertion of force is generally greatest when the pedal is in a horizontal position. From the top (position is defined as 0) to horizontal (position here is defined as π/2), the exertion of force increases and from the horizontal to the bottom position (defined as n), the exertion of force decreases again. The pedalling profile may also be different in the case of clipless pedals or in the case of stand-up riding. The drive power should be set as synchronously as possible to the exertion of force on the pedal. Even if a person exerts more force on a pedal, e.g. because they are travelling uphill or accelerating, then this is detected by the sensor and also more support power is provided by means of the drive unit. If the pedal is a clipless pedal, then a force from the pedal between π and 2π (top position) may additionally also be exerted.

The advantage of a sensor system according to the disclosure having a sensor co-rotating with the crankshaft is that the sensor system—as also explained in more detail in the following—manages with sensors which only take up a small installation space. In addition, the concept is not based on magnetic sensors, as a result of which magnetized components do not have an effect on the measurement and also no demagnetization has to be carried out. As also explained in more detail in the following, the sensor arrangement according to the disclosure also opens up novel possibilities for detecting the component load.

An acceleration sensor in particular is used as sensor. The acceleration sensor is arranged on the circumference of the crankshaft in particular and rotates with the same. Then the acceleration of the crankshaft in the circumferential direction or a change of the circumferential speed of the crankshaft can be determined by means of the acceleration sensor as a value representing the exertion of force. A piezoelectric acceleration sensor or a micro-electro-mechanical system (MEMS) is used here in particular as acceleration sensor. Such an acceleration sensor takes up particularly little installation space.

Alternatively or additionally, the at least one sensor is an angular rate sensor. A micro-electro-mechanical system (MEMS) can likewise be used as angular rate sensor, the measuring principle of which makes use of the Coriolis force for example or which functions optically. By means of the angular rate sensor, a change of the angular velocity of the crankshaft can be determined, which also depends on how forcefully the pedal is pedalled.

In a practical embodiment of the sensor system according to the disclosure, the at least one acceleration sensor is arranged on the crankshaft in such a manner that an acceleration in the tangential direction of the crankshaft can be detected by means of this acceleration sensor. In this case, in the tangential direction means that the acceleration sensor detects an acceleration in the direction of rotation of the crankshaft. In the tangential direction, acceleration transmitted from a pedal to the crankshaft has a particularly pronounced effect.

In particular, the at least one acceleration sensor is arranged on the crankshaft in such a manner that an acceleration in the radial direction of the crankshaft can be detected by means of this acceleration sensor. Acceleration of the crankshaft caused by the exertion of a force on a pedal can likewise be detected in the radial direction. In addition, an acceleration of the entire bicycle in the longitudinal direction of the bicycle can be detected in the radial direction.

Alternatively or additionally, the at least one acceleration sensor is arranged on the crankshaft in such a manner that an acceleration in the axial direction of the crankshaft can be detected by means of this acceleration sensor. The axial direction of the crankshaft corresponds to the transverse direction of the bicycle. An angular rate sensor can also be arranged on the crankshaft in such a manner that the same detects torsion about the longitudinal direction of the bicycle (also termed swaying). For example, side to side rocking of the bicycle, as occurs when riding out of the saddle uphill or when starting to ride the bicycle, can be detected from this. Here also, the support due to the drive device can then be adjusted accordingly.

In particular, at least two or even all three of the previously mentioned acceleration sensors are arranged on the crankshaft. If a plurality of acceleration sensors is arranged on the crankshaft, which measures the acceleration in different directions, then more precise measurement data can be obtained from a combination of the various acceleration data, which measurement data contribute to improving the support of the person by the drive unit. In particular, the acceleration in the longitudinal direction of the bicycle and in the direction of rotation can be determined more accurately from a combination of the detected accelerations in the tangential direction and in the radial direction of the crankshaft over a revolution of the crankshaft. If the sensor unit comprises a plurality of acceleration sensors, then these can also be integrated in a component in the known manner. This component is furthermore very compact and space-saving.

Alternatively or additionally, a plurality of angular rate sensors can also be arranged on the crankshaft, which measure in different directions. Also, a more precise evaluation of the exertion of force on the pedal can take place from a combination of these measurement data.

In a further practical embodiment of the sensor system according to the disclosure, the at least one sensor is arranged on a ring. The ring is connected to the crankshaft in a rotationally fixed manner. In particular, the ring is arranged to externally surround the crankshaft, e.g. by means of a press fit. By means of a ring, the at least one sensor can easily be connected to the crankshaft and co-rotate with the same. A structural modification of the crankshaft is not required, crankshafts that are available as standard can be used. The ring may be present as a closed ring or else as a split ring (ring section). The ring may be a flat ring with a small extent in the axial direction or else a ring which has a larger extent in the axial direction and is of cylindrical construction.

In particular, the sensor unit has a plurality of sensors arranged in a distributed manner over the circumference of the crankshaft. In particular, a plurality of acceleration sensors is arranged in a distributed manner over the circumference of the crankshaft, which measures the acceleration in the same direction, and/or a plurality of angular rate sensors, which measures the angular velocity about the same axis. For example, two, three or more sensors may be arranged in a distributed manner over the circumference, which detect the acceleration of the crankshaft in the direction of rotation in each case. In particular, in each case two or three acceleration sensors, which measure the acceleration in various directions, can also be integrated into a component, wherein a plurality of these integrated acceleration sensors is arranged in a distributed manner over the circumference. The same is true for the angular rate sensors.

By means of a plurality of sensors distributed over the circumference, it is in particular possible to detect the wear or a deformation and/or twisting of the crankshaft.

Particularly in connection with a previously described ring, the arrangement of a plurality of sensors along this ring is simple to realize.

In order to further optimize the accuracy of the measurement and therefore the adjustment of the support power, it is possible that the sensor unit additionally also has at least one magnetometer. The acceleration due to gravity currently acting on the sensor can be determined by means of the magnetometer. This is advantageous in the case of acceleration sensors in particular. After the compensation of the acceleration due to gravity, a linear speed can be calculated from the linear acceleration. Alternatively or additionally, an external cadence measurement can be carried out as a reference measurement. This cadence measurement could be realized at the sprocket using a light sensor or a Hall effect sensor.

In particular, in each case three acceleration sensors and three angular rate sensors, which are respectively orientated orthogonally to one another, can be combined in what is known as an IMU (inertial measuring unit). After compensation of the acceleration due to gravity, from the measured values of the IMU detected by the acceleration sensors, the linear speed can be determined by integration and the position of the respective IMU relative to a reference point can be determined by further integration. The integration of the three angular velocities determined by the angular rate sensors delivers the orientation of the IMU (tilting) relative to a reference point.

In particular, a plurality of IMUs is arranged in a distributed manner over the circumference of the crankshaft here and in particular on a ring which is connected to the crankshaft in a rotationally fixed manner.

In a further practical embodiment of the sensor system according to the disclosure, a slip ring is connected to the at least one sensor. The slip ring is used in particular for energy transmission for the supply of the sensor and/or for data transmission of the measured value. By means of the slip ring, information or energy of components that are rotating relatively to one another—here between the rotating sensor and an energy supply and/or control unit which is stationary, i.e. arranged in a rotationally fixed manner on a frame of the bicycle. Preferably, the at least one sensor is arranged on the front side or the front end side of a ring, the rear side or rear end side of which has sliding contacts. Alternatively, the at least one sensor can be arranged on the inner side of the slip ring and the sliding contacts can be arranged on the outer side. The aforementioned is suitable in particular for a tubular, cylindrical ring (drum). The sliding contacts are contacted in particular by means of brushes, which are arranged in a rotationally fixed manner on the frame of the bicycle, via a sliding contact.

The sensor system is particularly space-saving if the slip ring for the sensor system is at the same time the slip ring for energy transmission and/or data transmission for a drive unit for providing a support power for the bicycle. The slip ring then has a plurality of poles, which are in each case connected to the drive unit and/or to the at least one acceleration sensor. The previously described arrangement is particularly suitable for co-rotating drive units arranged in the crankshaft.

The data transmission can also be carried out via telemetry, e.g. wirelessly via radio, WLAN or Bluetooth.

It may also be provided that additionally, a reference acceleration sensor is arranged in a stationary manner on a frame of the bicycle. This acceleration sensor can be used inter alia for comparing the measured values of the co-rotating sensor.

The disclosure also relates to a drive unit for providing a support power for a bicycle having a sensor system as described previously. The drive unit is supplied with energy by means of a battery/a rechargeable battery in particular and supports the person on the bicycle with forward movement. This is an electrical drive unit in particular. The type of support can be realized in various ways. In particular, the drive unit provides an auxiliary torque, which acts on the cranks (also termed a mid-drive motor). Alternatively, the provision of an auxiliary torque to a hub (hub motor) is also conceivable.

The disclosure furthermore comprises a sensor unit having a ring for rotationally fixed connection to a crankshaft of a bicycle, wherein the ring has at least one sensor. The sensor is designed to detect a value representing the exertion of force on a pedal at the crankshaft. In particular, the at least one sensor is an acceleration sensor or an angular rate sensor. The ring is a slip ring in particular, by means of which the sensor can be supplied with energy and/or by means of which the control of the sensor takes place and the measured values can be transmitted. The sensor is connected to a control unit for a drive unit of a bicycle in particular. The ring can be a closed ring or else a ring with a slot, i.e. a ring section. A tubular, cylindrical ring or a drum is also termed a ring here. Such a cylindrical ring has a larger extent in the axial direction than a flat ring.

The disclosure also comprises a method for setting a support power of a drive unit of a bicycle, particularly electrical support. By means of at least one sensor, which is connected to a crankshaft in a rotationally fixed manner, a value representing the exertion of force on a pedal is detected at the crankshaft and the support power of the drive unit is adjusted as a function of the detected value. As already explained previously, the application of force can in particular be detected indirectly in a simple manner by means of the acceleration of the crankshaft or the angular velocity of the crankshaft and the support power can correspondingly be adjusted. A particularly pleasant riding experience results due to the precise setting of the support power. Reference is made to the previous description with respect to further advantages.

In particular, the acceleration of the crankshaft in the direction of rotation is detected by means of an acceleration sensor. The exertion of force via the pedal has a particularly strong effect in the direction of rotation or in the tangential direction of the crankshaft and can therefore be detected particularly accurately.

Alternatively or additionally, the change of the rotational speed of the crankshaft is detected by means of an angular rate sensor.

Furthermore, the movement of the bicycle in the longitudinal direction of the bicycle can be detected by means of at least one acceleration sensor. Therefore, the speed of the bicycle can be determined inter alia.

A lateral acceleration of the bicycle, transverse to the longitudinal direction of the bicycle, is detected in particular by means of at least one acceleration sensor and/or torsion of the bicycle about the longitudinal direction of the bicycle is detected by means of an angular rate sensor. Therefore, it is for example possible to detect whether a person is riding out of the saddle and a particularly high load is present, which requires an increased adjusted support power in particular.

A torsion of the bicycle about the vertical direction of the bicycle can also be detected by means of at least one angular rate sensor, wherein yawing or rolling of the bicycle is determined and after that the support power is adjusted. If an unstable riding situation is detected by the sensors, the support power can in particular be reduced, and in particular other components such as brakes or ABS can additionally be activated/actuated.

It may furthermore be provided that an acceleration in the vertical direction of the bicycle is determined from acceleration values detected by at least two acceleration sensors. In the vertical direction of the bicycle in this case means in particular that uphill and downhill rides of the bicycle can be identified. In the case of an uphill ride, i.e. a climb, the support power can then likewise be adjusted and in particular increased. Alternatively or additionally, an incline caused e.g. by an uphill or downhill ride can also be determined by means of at least one angular rate sensor. The incline can in particular also be detected by means of the (co-rotating) magnetometer.

If a plurality of acceleration sensors and/or angular rate sensors are arranged in a distributed manner around a circumference of the crankshaft, a deformation of the crankshaft can be determined on the basis of the relative position thereof. To this end, a position determination of each individual acceleration and/or angular rate sensor takes place. If for example, three acceleration sensors or IMUs are arranged in a uniformly distributed manner over the circumference of the crankshaft, then they form an equilateral triangle in the case of a perfectly round crankshaft. If the crankshaft is deformed, then the triangle formed is also distorted. By means of the deformation of the crankshaft, conclusions can be drawn about the loading of the crankshaft and in particular whether the crankshaft should possibly be replaced or should be repaired. Customized maintenance of the crankshaft can be realized with the aid of the detection of the relative positions.

In a further practical embodiment of the method according to the disclosure, the measured acceleration values are compared with measured acceleration values of a reference sensor connected to a frame of the bicycle in a stationary manner. In particular, the acceleration in the longitudinal direction of the bicycle and/or in the vertical direction of the bicycle can be verified in this manner and therefore the accuracy of the acceleration values for the acceleration of the crankshaft in the direction of rotation can also be improved.

### BRIEF DESCRIPTION OF THE DRAWINGS

Further practical embodiments and advantages are described in the following in connection with the figures. In the figures:

FIG. 1 shows a frame of a bicycle having a sensor system in a perspective view obliquely from the front,

FIG. 2 shows a sensor system in a perspective view from obliquely above,

FIG. 3 shows a sensor unit in a first embodiment in a front view,

FIG. 4 shows the sensor unit from FIG. 3 in a side view,

FIG. 5 shows the sensor unit from FIGS. 3 and 4 in a rear view,

FIG. 6 shows a sensor system having a sensor unit according to the first embodiment in a perspective view,

FIG. 7 shows a sensor unit in a second embodiment in a front view,

FIG. 8 shows the sensor unit from FIG. 7 in a side view,

FIG. 9 shows the sensor unit from FIGS. 7 and 8 in a section according to line IX-IX in FIG. 7,

FIG. 10 shows a sensor system having a sensor unit according to the second embodiment in a perspective view,

FIG. 11 shows a sensor unit in a schematic illustration,

FIG. 12 shows a graph of the tangential forces,

FIG. 13a shows a sensor system with an intact crankshaft in a schematic illustration, and

FIG. 13b shows the sensor system from FIG. 13a with a deformed crankshaft in a schematic illustration.

### DETAILED DESCRIPTION OF THE DRAWINGS

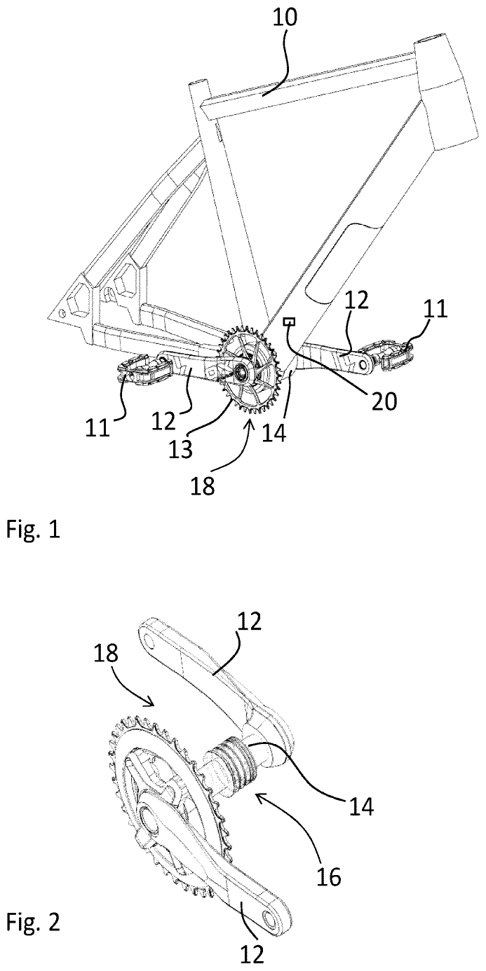

A frame 10 for a bicycle is shown in FIG. 1. A frame 10 of this type is known from the prior art.

The frame 10 for the bicycle has two pedals 11, which are in each case connected via a crank 12 to a crankshaft 14. The crankshaft 14 is rotatably mounted in the frame 10 and transmits the torque coming from the pedals 11 to the gear 13 and subsequently the rear wheel (not illustrated).

The present bicycle is an electric bicycle, which has a drive unit (not visible here) and a rechargeable battery (likewise not visible) for supplying energy to the drive unit. The drive unit provides an auxiliary torque, which here acts on the crankshaft 14.

The crankshaft 14 together with a sensor unit 16 (cf. FIG. 2 inter alia) forms a sensor system 18. Further, a second reference sensor 20 is also arranged in a stationary manner on the frame 10 here.

FIG. 2 shows a sensor system 18 having a crankshaft 14 and a sensor unit 16, which is connected to the crankshaft 14 in a rotationally fixed manner.

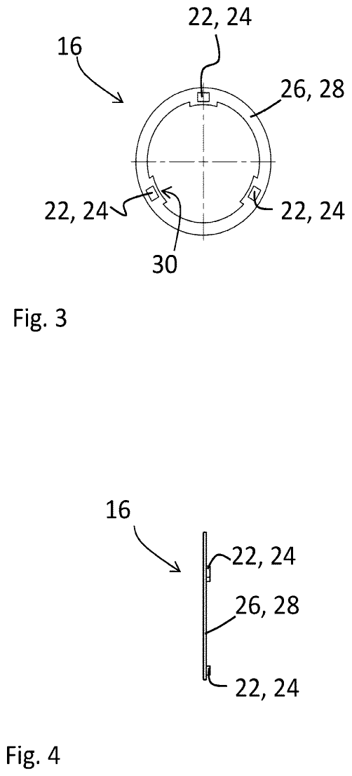

In connection with FIGS. 3 to 5, first a sensor unit 16 is explained in a first embodiment. The sensor unit 16 here comprises a plurality of sensors 22, which are actually integrated into three IMUs 24. An IMU 24 in each case comprises three acceleration sensors, which are orientated orthogonally to one another, and three angular rate sensors in a modular unit. The three IMUs 24 are arranged on the front side of a ring 26. The ring 26 here is a flat ring 26. The IMUs 24 are arranged at the same distances, equidistantly over the circumference of the ring 26.

In the side view in FIG. 4, it is clearly visible that the IMUs 24 are arranged on the front side of the ring 26 and protrude with respect to the same.

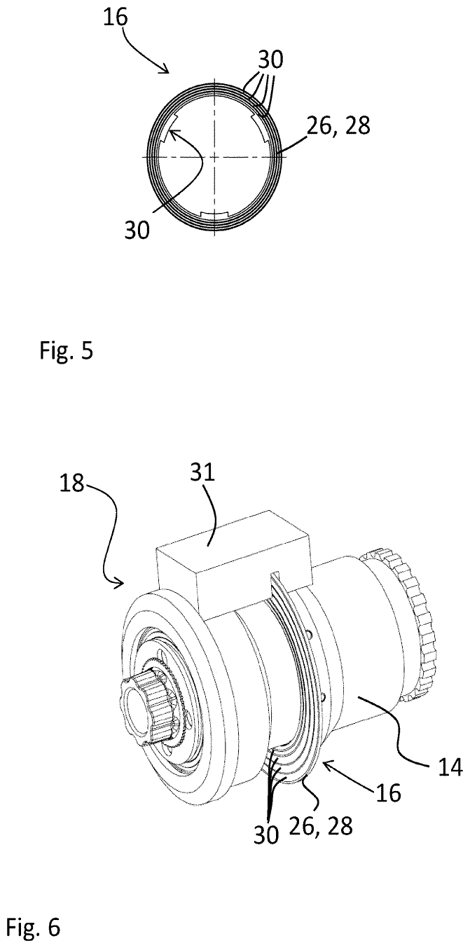

The ring 26 is a slip ring 28 and has four annular contacts 30 on the rear side (cf. FIG. 5), wherein two contacts 30 are signal lines, one contact 30 is available for supplying energy to the sensors 22 and one contact 30 is the earth contact.

The ring 26 is also used for arranging the at least one sensor 22 and here the plurality of IMUs 24 on the crankshaft 14. To this end, the ring 26 has three arcuate projections 32 extending over an arcuate section on the inner side thereof. The ring 26 is arranged on the outside of the crankshaft 14. The diameter of the opening formed by the projections 32 is designed in such a manner that the ring 26 can be connected to the crankshaft 14 by means of press fit.

In FIG. 6, a sensor system 18 is illustrated, which comprises the crankshaft 14 and the sensor unit 16 according to the previously described first embodiment. Here, it can be seen well that the ring 26 or the slip ring 28 is arranged to surround the crankshaft 14 and that the contacts 30 of the slip ring 28 are contacted via a reading unit 31, which is connected in a stationary manner to the frame 10, by means of brushes.

In the following, the same reference numbers are used for identical or at least functionally identical elements to describe further embodiments as to describe the first embodiment.

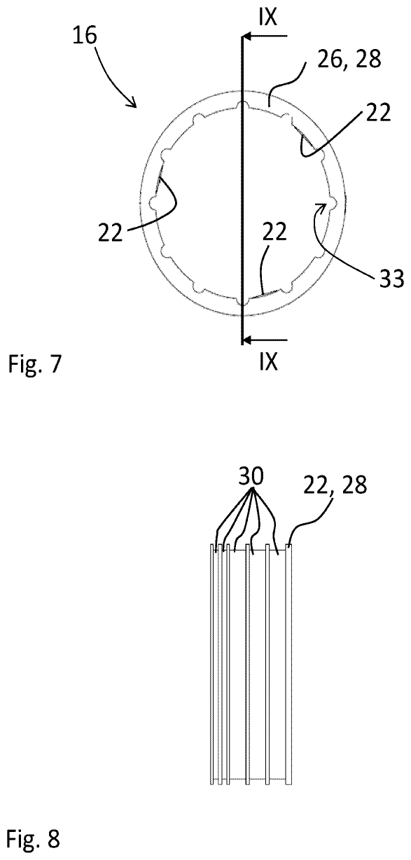

In FIGS. 7 to 10, a sensor unit 16 is illustrated in a second embodiment.

The sensor unit 16 here also comprises a plurality of sensors 22. The three sensors 22 are arranged on the inner side of the ring 26 here. The sensors 22 may be simple acceleration sensors or else IMUs 24. Here, the ring 26 is a tubular cylindrical ring 26, as can be seen well in FIGS. 8 to 10. The sensors 22 are arranged at the same distances, equidistantly over the inner circumference of the ring 26. The ring 26 has a plurality of hemispherical depressions 33 on the inner side. The depressions 33 are used to produce a certain elasticity. In addition, the slip ring 28 has cable bushings 36.

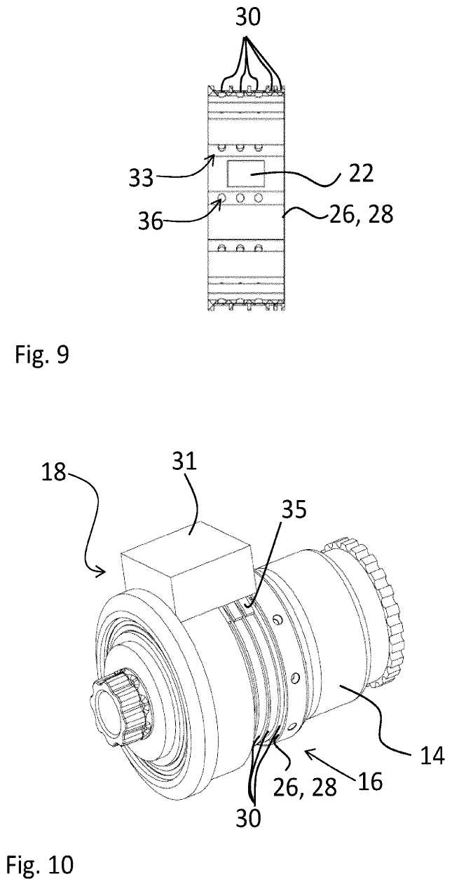

The ring 26 is a slip ring 28 and is also used at the same time here for connecting a drive unit, which is arranged inside the crankshaft 14. The slip ring 28 has five annular contacts 30 on the outer side (cf. FIGS. 8 and 9). A contact 30 is the earth contact for the sensors 22 and one contact 30 is used for supplying energy to the sensors 22. Three further contacts 30 are provided for the three phases of the drive unit, wherein the signal line for the sensors 22 is modulated to one phase.

In FIG. 10, a sensor system 18 is illustrated, which comprises the crankshaft 14 and the sensor unit 16 according to the previously described second embodiment. Here, the ring 26 or the slip ring 28 is likewise arranged to surround the crankshaft 14. The contacts 30 are then orientated parallel to the axial direction of the crankshaft 14 and contacted via a reading unit 31, which is connected in a stationary manner to the frame 10, by means of sliding contacts 35.

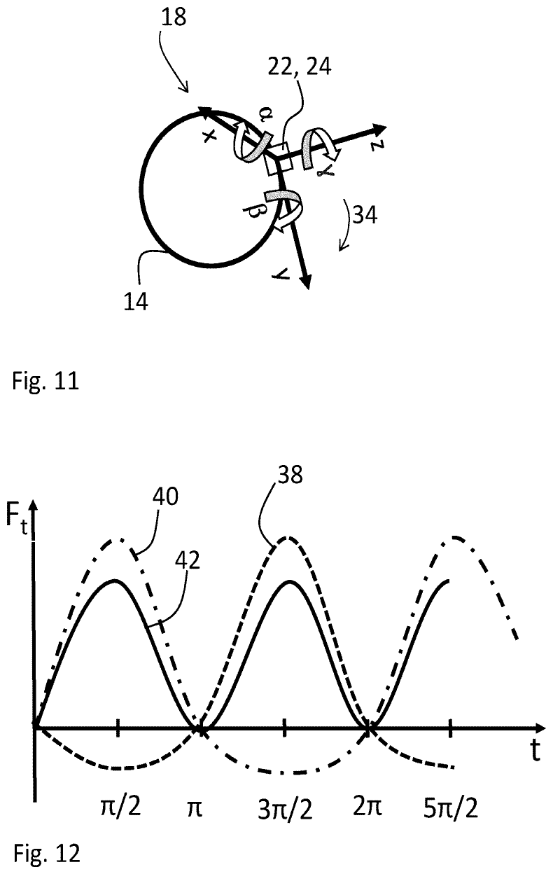

FIG. 11 schematically shows a sensor system 18 having an IMU 24, wherein the IMU 24 is arranged in a rotationally fixed manner on the crankshaft 14.

The direction of rotation of the crankshaft 14 is indicated by the arrow 34. The IMU 24 rotates with the crankshaft 14. In this case, accelerations are measured in three directions by means of the three acceleration sensors 22 in the IMU 24: an acceleration in the direction of rotation of the crankshaft 14 (here a_{y}) can be determined by means of a first acceleration sensor. Here, a conclusion is drawn in particular about application of force on a pedal 11 from the acceleration in the direction of rotation. Furthermore, a further acceleration sensor is used to measure the acceleration in the radial direction of the crankshaft 14 (here a_{z}). The acceleration of the crankshaft 14 can be determined particularly accurately from a_{y} and a_{z}. A third acceleration sensor measures an acceleration in the axial direction of the crankshaft 14 (here aₓ). This can be used to detect e.g. riding out of the saddle.

In addition, three angular rate sensors are arranged, which respectively measure torsion about the axes aₓ, a_{y}, a_{z}. The individual angles are then labelled α, β, γ. For example, the rotational speed of the crankshaft can be determined by means of the change of the torsion labelled with a here.

The operating principle of the sensor system 18 is explained in the following in connection with FIG. 12.

In FIG. 12, the tangential force Ft is applied, which acts on the crankshaft 14 over the position t of the crankshaft 14.

The curve of the tangential force over approximately one and a half revolutions of the crankshaft 14 is illustrated by way of example in FIG. 12. In this case, the dashed line 38 and the dot-dashed line 40 respectively indicate the curve of the tangential force for a pedal 11. The solid line 42 is the force curve, which results at the crankshaft 14 by means of the rotation using both pedals 11.

In the section from 0 to π/2, the tangential force, which is exerted by a person on a pedal 11, increases (cf. curve 40) and reaches its maximum at π/2. From π/2 to π, the tangential exertion of force then falls to 0. In the section from n via 3/2π to 0, the person does not exert any force on the pedal 11, rather force must be exerted (via the other pedal 11), in order to convey the pedal 11 back to the top.

In the event of riding out of the saddle or stand-up riding or else when using the bicycle with clipless pedals, the curve of the tangential force may deviate from the curve illustrated in FIG. 12. The support power can then be adjusted to the respective curve.

This force curve can be determined by means of the sensor unit 16 and in particular a change in the strength of the force (here the amplitude) can be determined, which then also lead to an adjustment of the support power by the drive unit.

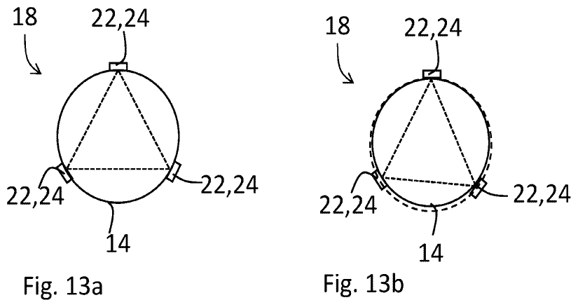

A further possibility, which the sensor system 18 offers, is described in the following in connection with FIG. 13a and FIG. 13b. In FIG. 13a, an intact, circular crankshaft 14 is shown in cross section, on the outer circumference of which three acceleration sensors 22 or three IMUs 24 are arranged at uniform distances from one another. The three acceleration sensors 22 or three IMUs 24 form an isosceles triangle. In FIG. 13b, the crankshaft 14 is illustrated in a deformed manner, wherein the original geometry is indicated with a dashed line. The crankshaft 14 is additionally also twisted. This leads to a displacement of the relative positions of the acceleration sensors 22/the IMUs 24 (visible from the distorted triangle). On the basis of the deviation of the relative position from the desired position in the case of a circular crankshaft 14, it is possible to draw a conclusion about a deformation and/or twisting of the crankshaft 14.

1. A sensor system having a sensor unit for determining the exertion of a force on a pedal of a bicycle,
wherein
the sensor unit is connected in a rotationally fixed manner to a crankshaft of the bicycle, which is connected to the pedal, wherein the sensor unit comprises at least one sensor, which detects a value at the crankshaft representing the exertion of force.

2. The sensor system according to the claim 1,
wherein
the at least one sensor is an acceleration sensor.

3. The sensor system according to claim 1,
wherein
the at least one sensor is an angular rate sensor.

4. The sensor system according to claim 2,
wherein
the at least one acceleration sensor is arranged on the crankshaft in such a manner that an acceleration of the crankshaft in the tangential direction of the crankshaft can be detected using the at least one acceleration sensor.

5. The sensor system according to claim 2,
wherein
the at least one acceleration sensor is arranged on the crankshaft in such a manner that an acceleration in the radial direction of the crankshaft can be detected using the at least one acceleration sensor.

6. The sensor system according to claim 2,
wherein
the at least one acceleration sensor is arranged on the crankshaft in such a manner that an acceleration in the axial direction of the crankshaft can be detected using the at least one acceleration sensor and/or in that at least one angular rate sensor is arranged on the crankshaft in such a manner that torsion about the longitudinal direction of the bicycle can be detected using the at least one angular rate sensor.

7. The sensor system according to claim 1,
wherein
the at least one sensor is arranged on a ring.

8. The sensor system according to claim 1,
wherein
the sensor unit has a plurality of sensors arranged in a distributed manner over the circumference of the crankshaft.

9. The sensor system according to claim 1,
wherein
the sensor unit additionally has a magnetometer.

10. The sensor system according to claim 1,
wherein
a slip ring is connected to the at least one sensor.

11. The sensor system according to claim 10,
wherein
the slip ring is at the same time the slip ring for energy transmission and/or data transmission for a drive unit for providing a support power for the bicycle.

12. The sensor system according to claim 1,
wherein
a reference acceleration sensor is arranged in a stationary manner on a frame of the bicycle.

13. A drive unit for providing a support power for a bicycle having a sensor system according to claim 1.

14. A sensor unit comprising a ring for rotationally fixed connection to a crankshaft of a bicycle,
wherein
the ring has at least one sensor, wherein the sensor is designed to detect a value representing the exertion of force on a pedal at the crankshaft.

15. A method for setting support power of a drive unit of a bicycle,
wherein
by means of at least one sensor, which is connected to a crankshaft in a rotationally fixed manner, a value representing the exertion of force on a pedal is detected at the crankshaft and the support power of the drive unit is adjusted as a function of the detected value.

16. The method according to claim 15,
wherein
the acceleration of the crankshaft is detected using an acceleration sensor.

17. The method according to claim 1,
wherein
the change of the rotational speed of the crankshaft is detected using an angular rate sensor.

18. The method according to claim 1,
wherein
the movement of the bicycle in the longitudinal direction of the bicycle is detected using at least one acceleration sensor.

19. The method according to claim 1,
wherein
a lateral acceleration of the bicycle in the transverse direction of the bicycle is detected using at least one acceleration sensor, and/or torsion about the longitudinal direction of the bicycle is detected using at least one angular rate sensor.

20. The method according to claim 1,
wherein
torsion about the vertical direction of the bicycle is detected using at least one angular rate sensor.

21. The method according to claim 1,
wherein
a plurality of acceleration sensors and/or angular rate sensors are arranged in a distributed manner around a circumference of the crankshaft and a deformation of the crankshaft is determined on the basis of the relative position thereof.

22. The method according to claim 1,
wherein
the measured values are compared with measured acceleration values of a reference sensor connected to a frame of the bicycle in a stationary manner.
